(19) United States
(12) Patent Application Publication
(10) Pub. No.: US 2008/0086342 A1
(43) Pub. Date: Apr. 10, 2008

(54) METHODS OF ASSESSING FRAUD RISK, AND DETERRING, DETECTING, AND MITIGATING FRAUD, WITHIN AN ORGANIZATION

(76) Inventors: Edith L. CURRY, Glen Allen, VA (US); Frank HAILSTONES, Orlando, FL (US); Michael A. DEMENT, Williamsburg, VA (US); Laurie S. HOLTZ, Miami Beach, FL (US)

Correspondence Address: HAHN LOESER & PARKS, LLP, One GOJO Plaza, Suite 300, AKRON, OH, 44311-1076, US

(21) Appl. No.: 11/539,715

(22) Filed: Oct. 9, 2006

(51) Int. Cl. G06Q 40/00

(52) U.S. Cl. 705/7

(57) ABSTRACT

A method to assess risk of fraud within an organization is disclosed. A review of an organization's business processes with respect to risk is performed. A first business process fraud risk map is generated based on the review by generating and assigning first risk values to the business processes of the organization. The first business process fraud risk map is correlated to positions of responsibility within the organization and second risk values are generated and assigned to the correlated positions. Business processes may be adjusted in an attempt to reduce a number of positions deemed to be of relatively high risk. Individual persons holding positions subject to risk may be designated for going through a fraud risk determination (e.g., certification) process and subsequent monitoring process, all designed to reduce fraud risk by helping deter and/or detect and/or mitigate fraud.

### TECHNICAL FIELD

Certain embodiments of the present invention relate to methods to reduce fraud by assessing and reducing the risk of fraud, and by deterring, and/or detecting, and/or mitigating fraud occurring within an organization.

### BACKGROUND OF THE INVENTION

Fraud is perpetrated by individuals, and their behaviors and activities can indicate that they have committed, and provide leading indicators that they will commit, fraud. How an individual earns, saves, invests, manages, and spends money are key factors. Typically, fraud begins with the individual telling himself, “ . . . just this once, I'll pay it back.” But once that line is crossed, the individual rarely turns back. It becomes easier and easier for the individual to justify the fraudulent behavior/acts, with the amount defrauded steadily increasing before being detected, if at all.

One source of the problem stems from the leadership of organizations (e.g., board of directors and senior management). For example, a passive, non-independent, and rubber-stamping board of directors composed of members selected by the CEO or chairman of the board does not guarantee effective oversight of management actions and conduct.

Moreover, management teams that place personal interests above creating value for the organization and its investors when conducting the affairs of the corporation incur a systemic conflict of interest. In the past, breaches of fiduciary duty by management and boards of directors were sometimes condoned by auditors who lacked independence and possessed limited capability and authority to challenge management.

The Sarbanes-Oxley Act (SOA) of 2002 was designed to protect shareholders and workers and gave the federal government new powers to enforce corporate responsibility and to improve oversight of publicly traded corporations. This legislation gave new power to prosecutors and regulators seeking to improve corporate responsibility and protect shareholders and workers. Among other reforms, the legislation:

increased the accountability of officers and directors;

created a new securities fraud provision with a 25-year maximum term of imprisonment;

directed the Sentencing Commission to review sentencing in white collar crime, obstruction of justice, securities, accounting, and pension fraud cases;

required CEOs and Chief Financial Officers (CFOs) to certify personally financial reports submitted to the U.S. Securities and Exchange Commission fully comply with securities laws and fairly present, in all material respects, the financial condition of their companies;

criminalized retaliatory conduct directed at corporate whistleblowers and others.

The Sarbanes-Oxley Act places considerable emphasis on correcting lax corporate governance practices, including:

management dealing in an environment rife with conflicts of interest;

lack of strict transparency, reliability, and accuracy standards in financial reporting;

lack of independence of key players in corporate governance, beginning with the board of directors, senior management, and auditors;

lack of adequate enforcement tools for regulators; and

widespread conflicts of interest influencing securities market transactions.

Addressing the systemic weakness of the corporate governance practices in the post-Sarbanes-Oxley corporate environment requires more than correcting the most visible manifestations of the problem.

Laws and regulations have always proven to be insufficient to guarantee society's welfare or, in this case, improvement in corporate governance standards. In many ways, Sarbanes-Oxley has merely made express the duties and responsibilities of boards, CEOs, and CFOs and taken away from them the ability to blame someone else if fraud and abuse occur at a company covered by Sarbanes-Oxley. However, these duties existed before Sarbanes-Oxley was enacted, albeit in less explicit fashion. While it may be comforting to some that Sarbanes-Oxley has eliminated the ability of senior management to claim they did not know or were not aware, this is still unlikely to prevent people from committing the types of fraud and abuse that led to the passage of Sarbanes-Oxley in the first place.

While Sarbanes-Oxley will play a role in ensuring that U.S. companies avoid certain excesses, the market and investors should continue to seek out solutions that are driven by market needs that help restore and maintain the confidence of investors in public companies.

Accountability is the key in any type of organization. The owners of public corporations (i.e., the shareholders) must hold managers, directors, and auditors accountable. The performance of these groups directly impacts shareholder value. The corporate governance process must guarantee performance excellence by management and the board of directors.

Members, shareholders, investors, and tax payers must hold the leaders of private companies, not-for-profit entities, and even governmental bodies accountable, as well. The performance of these leaders directly impacts the value of their organizations. Their governance processes must guarantee performance excellence by the organizations' leaders.

Although implementing corporate governance best practices can result in additional operating costs, good corporate governance is not an option but an obligation, if shareholder interest is to be protected. Compliance costs are only a small fraction of the large losses suffered by stockholders when boards and/or executive management do not comply with good corporate governance practices. Sarbanes-Oxley has taken great steps at ensuring proper corporate governance and has put some teeth into non-compliance penalties for boards and management.

Sarbanes-Oxley was a good first step in combating abuses. However, additional protections should be put in place to complement Sarbanes-Oxely and more directly address those problems which Sarbanes-Oxley, by itself, cannot solve such as, for example, fraud prevention.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

An embodiment of the present invention is a method to assess and reduce the risk of fraud within an organization. The method includes performing a review of the organization's business processes with respect to this risk. A business process fraud risk map is generated based on the review by generating and assigning first risk values to the business processes of the organization. The business process fraud risk map is correlated to positions of responsibility within the organization and second risk values are generated and assigned to the correlated positions based on the correlating step. In accordance with an embodiment of the present invention, the second risk values may be a composite value derived from two or more first risk values from the business processes. For any given position, the second risk value assigned to that position may place that position in one of several defined categories of risk (e.g., high, intermediate, low).

At least one of the business processes may be adjusted to reduce the number of positions which are assigned to higher risk categories or which exceed a defined threshold value of risk. The business process fraud risk map may then be updated by assigning updated (i.e., changed) first risk values to the adjusted business processes of the organization. The updated business process fraud risk map may be re-correlated to the positions of responsibility within the organization and updated (i.e., changed) second risk values assigned to the positions. The process may be repeated until the number of positions having a second risk value being in (i.e., falling into) a category of highest risk or being on a higher-risk side of a risk threshold value indicates an acceptable level of risk.

Once the number of positions in the various categories of degrees of fraud risk have been optimized (e.g., by reducing the number of positions in a high-risk category or by minimizing the number of positions exceeding a threshold of acceptable risk), individual persons within the organization who hold those positions may be identified. All, or a subset, of the identified persons may be selected to go through an anti-fraud risk (e.g., certification) process (a fraud risk determination process). Those persons selected are educated about the fraud risk determination (e.g., certification) process and begin the fraud risk determination process only after providing informed consent to go through the fraud risk determination process.

The fraud risk determination process includes obtaining a personal information disclosure statement from the individual person and obtaining personal financial records and other relevant data of the individual person. Information extracted from the personal information disclosure statement, the personal financial records, and the other relevant data is entered (input) into a risk assessment algorithm. The risk assessment algorithm operates on the input information and generates risk assessment data associated with the individual person. The risk assessment data is evaluated and a determination of fraud risk (e.g., certification) is made with respect to the individual person.

All individuals of an organization can, or can be requested by the organization to, apply for going through the fraud risk determination process (e.g., the certification process), in accordance with an embodiment of the present invention. The individual completes an information disclosure statement and gives the certifying entity permission to review their past and/or present information for, for example, the past 5 to 10 years depending on position(s) held. If the individual meets the risk criteria, they are certified as being a lower fraud risk. Such a certification process helps to drive the behaviors of individuals.

If, at any time during the certification period, issues of concern are identified, the corresponding event is investigated for accuracy, and, depending on the results of the investigation, certification may be suspended, cancelled, re-rated, or left unchanged. The certification entity, in accordance with an embodiment of the present invention, is an evaluator of risk (preferably an independent evaluator of risk, but possibly a self-policing evaluator of risk). The oversight and independent monitoring of key individuals are provided, thus identifying those most likely to be a fraud risk. Certain embodiments of the present invention use risk models which are based on a complex algorithm of predictive financial modeling, not on biographical data which could be used for profiling.

These and other advantages and novel features of the present invention, as well as details of illustrated embodiments thereof, will be more fully understood from the following description and drawings.

### BRIEF DESCRIPTION OF SEVERAL VIEWS OF THE DRAWINGS

FIG. 1 illustrates a flowchart of a first embodiment of a method to assess risk of fraud within an organization, in accordance with various aspects of the present invention.

FIG. 2 illustrates an exemplary risk pyramid derived from the steps performed in the method of FIG. 1, in accordance with an embodiment of the present invention.

FIG. 3 is a functional block diagram of an embodiment of a cooperative arrangement to help deter and/or detect fraud by monitoring the behavior/activity of an individual associated with an organization to help deter and/or detect fraud, in accordance with various aspects of the present invention.

FIG. 4 illustrates a flowchart of a first embodiment of a method to help deter and/or detect fraud by monitoring the behavior/activity of an individual associated with an organization using the cooperative arrangement of FIG. 3, in accordance with various aspects of the present invention.

FIG. 5 illustrates a flowchart of a second embodiment of a method to help deter and/or detect fraud by monitoring the behavior/activity of individuals associated with an organization using the cooperative arrangement of FIG. 3, in accordance with various aspects of the present invention.

FIG. 6 illustrates a flowchart of an embodiment of a method to help deter and/or detect fraud by monitoring an individual of an organization using the cooperative arrangement of FIG. 3, in accordance with various aspects of the present invention.

### DETAILED DESCRIPTION OF THE INVENTION

As used herein, the term “organization” generally refers to a publicly held corporation, a non-publicly held corporation, a private business, a for-profit business, a not-for-profit entity, a government entity, a non-governmental entity, an athletic organization (e.g., a sports team), or any other type of organization where it may be desirable to implement embodiments of the present invention. As used herein, the term “individual” refers to any individual person in, being considered for being placed in, or could be placed in, a position of responsibility and/or trust with respect to an organization, including, but not limited to, an officer of the organization, an employee of the organization, a prospective employee or member of an organization, a member of the board of directors of an organization, a major stockholder of the organization, an athlete, and anyone who has the ability to over-ride governance, policies, procedures, and/or controls of the organization, or who has the ability to over-ride public laws or good practices. As used herein, the term “risk” generally refers to the likelihood of an individual to commit fraud. As used herein, the term “independent” means not associated with another entity in terms of ownership or control. As used herein, the term “position” refers to a job and its associated responsibilities and opportunity for misconduct, not the individual person filling the position.

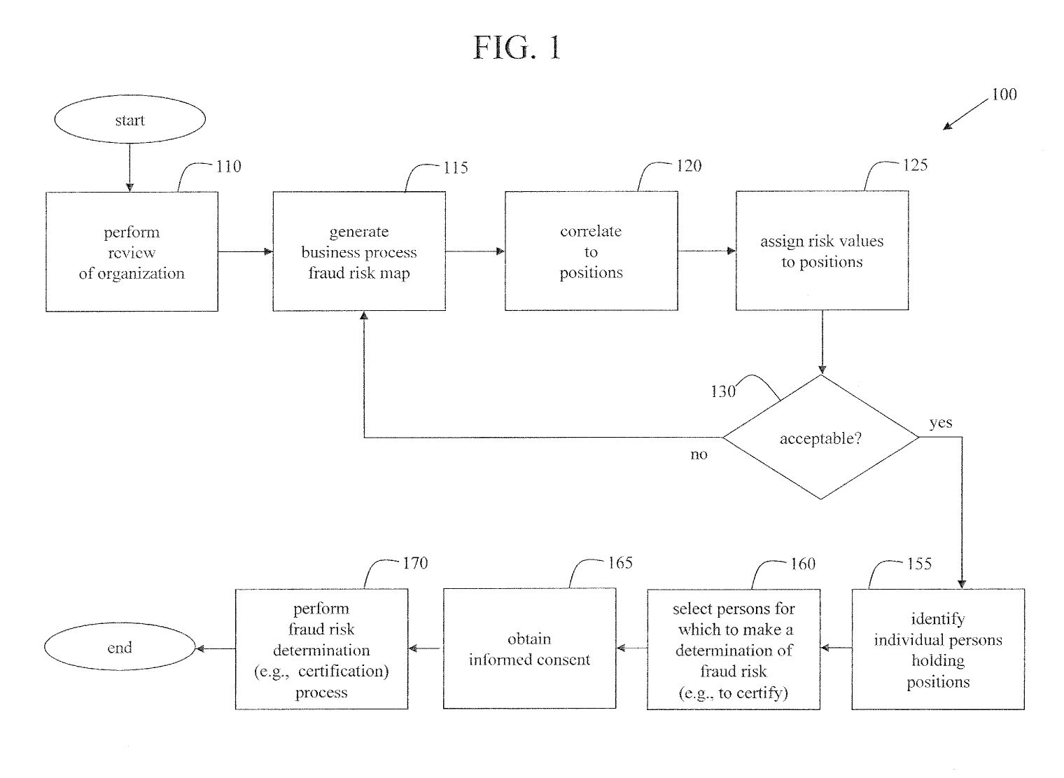

FIG. 1 illustrates a flowchart of a first embodiment of a method 100 to assess risk of fraud within an organization, in accordance with various aspects of the present invention. In step 110, a review of the organization's business processes is performed with respect to risk. Details of the review are disclosed later herein. In step 115, a business process fraud risk map is generated based on the review by generating and assigning first risk values to the business processes of the organization. In step 120, the business process fraud risk map is correlated to positions of responsibility within the organization. In step 125, second risk values are generated and assigned to the correlated positions based on the correlating step 120. In accordance with an embodiment of the present invention, the second risk values may be a composite value derived from two or more first risk values from the business processes. For any given position, the second risk value assigned to that position may place that position in one of several defined categories of risk (e.g., high, intermediate, low).

When determining risk as part of the method 100, organizational exposure is examined based on the idea that positions of responsibility at risk are equivalent to opportunity for individuals in those positions to commit fraud. Examples of some of the key criteria that are considered with respect to the positions (not necessarily the individual filling a particular position) include, but are certainly not limited to: the level of supervision given to a particular position (e.g., executive, board, supervisor); the level of executive or decision-making authority (e.g., ability to make commitments on behalf of the company or authorize payments or expenditures); the monitoring mechanisms employed within the organization to monitor behavior of a person in a particular position, and frequency of that monitoring (e.g., on-going, periodic, non-existent); the interfaces or the degree of interface the position has with others within the organization (e.g., organizational, dependencies); the geographic location of the position with respect to other positions, supervisors, security, etc. (e.g., remote, co-located); the type of organizational structure (e.g., centralized, de-centralized, devolving); the type of culture that exists within the organization (e.g., autocratic, democratic, collegial); the types of relationships that exist within the organization and the quality of same (e.g., partners, joint venture, external to company); the level of reporting that exists with respect to a particular position (e.g., level, frequency, content); how is the position compensated, motivated, rewarded (e.g., short-term stock price performance-based options); the organization's exposure to competitive pressures (e.g., the business environment); the stability of the organization with respect to various dimensions (e.g., systems, business cycle, predictability of business, senior team); the established controls within the organization (e.g., adequacy of separation of duties); the established standards within the organization (e.g., regulated, specific to the locale); the extent to which there is performance-based management (e.g., targets, review mechanisms); the maturity of the systems used in the organization (e.g., accounting, operations, subsidiary systems).

Referring again to FIG. 1, in step 130, a decision is made as to whether the number of positions having a second risk value being on a higher-risk side of a risk threshold value (e.g., being in a highest risk category) is acceptable. If not acceptable, then in step 135 at least one of the business processes is adjusted or modified in an attempt to change at least one corresponding first risk value reflecting a reduction in risk. The process resumes thereafter in step 115, with a second iteration (repeating) of steps 115 through 130 (i.e., re-generating, re-correlating, re-assigning).

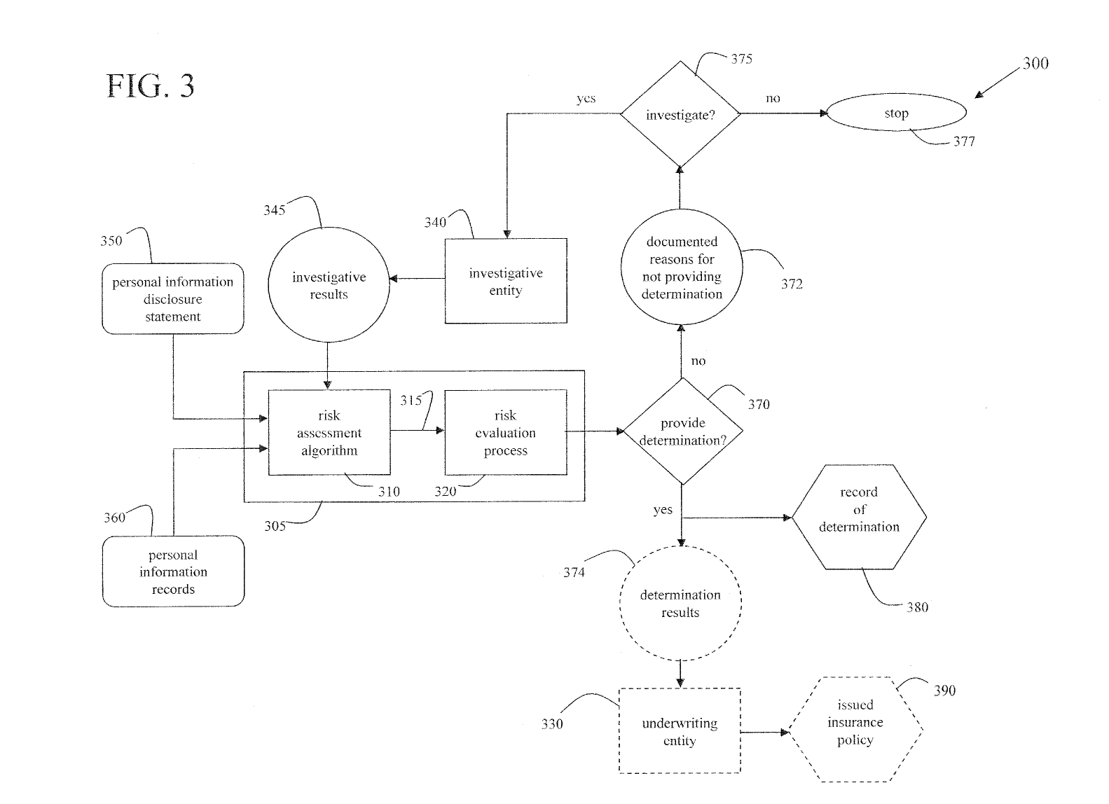

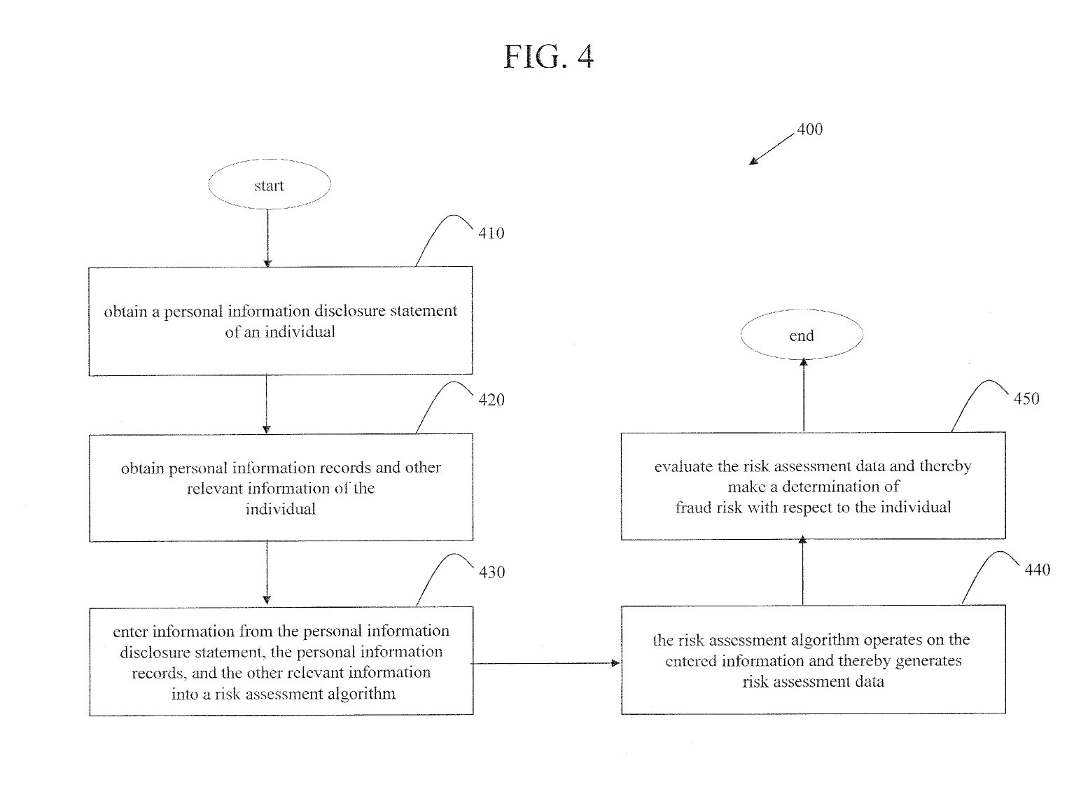

Again, in step 130, a decision is made as to whether the number of positions having a second risk value being on a higher-risk side of a risk threshold value (e.g., being in a highest risk category) is acceptable. If acceptable, then in step 155 individual persons within the organization who hold the positions having a second risk value being on the higher-risk side of the risk threshold value are identified. In step 160, at least one of the identified individual persons is selected for which to make a determination of fraud risk (e.g., to be certified according to a risk certification process). In step 165, an attempt is made to obtain an informed consent (to go through the risk certification process) from each of the individual persons selected to be certified. In step 170, each consenting individual person begins the fraud risk determination (e.g., risk certification) process. The fraud risk determination process is discussed later herein with respect to FIG. 3 and FIG. 4.

Any of a number of adjustments may be made to one or more business processes within an organization to reduce fraud risk. For example, certain checks and balances could be put in place with respect to a business process. One such check and balance is that of requiring at least two individuals to sign off on a particular type of financial statement. Another such check and balance is that of separating responsibilities with respect to a particular business process between two or more individuals.

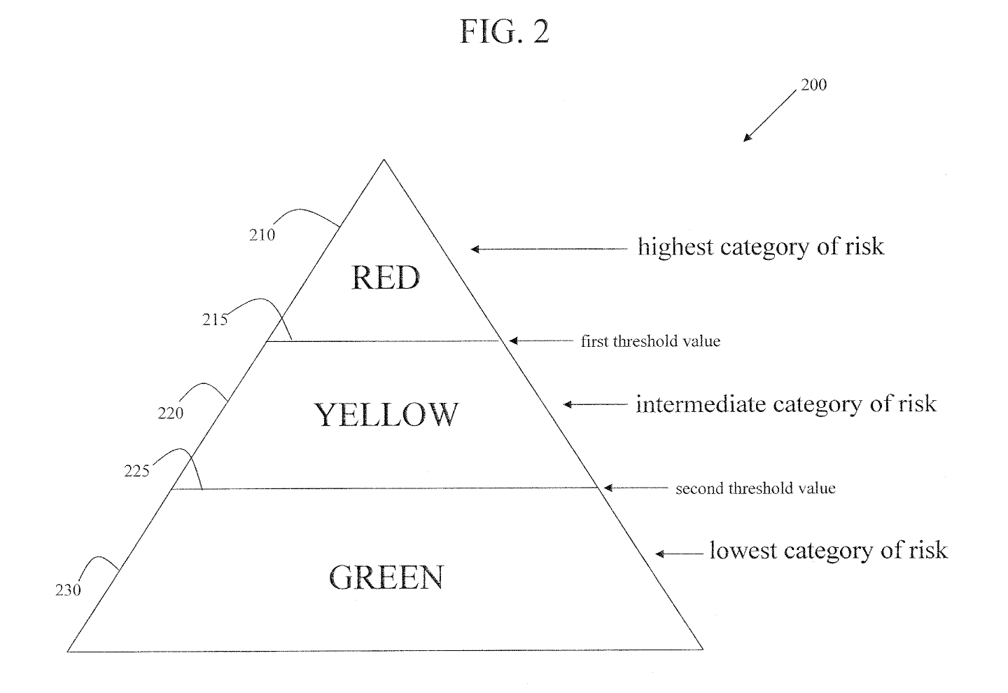

FIG. 2 illustrates an exemplary risk pyramid 200 derived from the steps performed in the method 100 of FIG. 1, in accordance with an embodiment of the present invention. The risk pyramid 200 represents a generally desired result of performing the steps 110 through 135 of the method 100 until acceptability is achieved in step 130. In accordance with an embodiment of the present invention, the risk pyramid 200 includes three categories of risk including a red category 210 (a highest category of risk), a yellow category 220 (an intermediate category of risk), and a green category 230 (a lowest category of risk). The categories of risk are separated by threshold values. For example, the yellow category 220 and the red category 210 are separated by the first threshold value 215, and the green category 230 and the yellow category 220 are separated by the second threshold value 225.

The positions of responsibility in the organization that have been determined to be the most risky with respect to opportunities for engaging in fraud are in the red category 210. The positions of responsibility in the organization that have been determined to be of moderate risk by the method 100 are in the yellow category 220. The positions of responsibility in the organization that have been determined to be of lowest risk are in the green category 230. Any number of categories of risk and threshold values may be defined, in accordance with various alternative embodiments of the present invention.

The analogy to a pyramid results in the fact that, for an organization having a particular number of positions of responsibility, most of the positions, after implementing the method 100, should fall in the green category 230 (i.e., having a risk value below the second threshold value 225), the next most should fall in the yellow category 220 (i.e., having a risk value between the first threshold value 215 and the second threshold value 225), and the fewest number of positions having the highest risk should fall in the red category 210, (i.e., having a risk value above the first threshold value 215). Before the method 100 is implemented, the distribution of positions across risk may not resemble a pyramid at all but instead may be, for example, relatively uniform and resemble a rectangle. The method 100 attempts to drive the initial distribution, whatever it is, to resemble a pyramid as just described.

According to the method 100, the business processes of the organization may be adjusted or modified such that the fewest possible number of positions fall in the red category 210. That is, the business processes may be changed to reduce the fraud risk associated with as many positions as possible. Such adjusting may include modifying certain control policies and procedures associated with, for example, financial reporting, appropriation of assets, expenditures and liabilities, obtaining revenue and assets, and incurring and/or reporting costs and expenses. Such adjusting may also include changing the separation of duties between positions within the organization.

Many fraudulent financial reporting schemes involve earnings management arising from improper revenue recognition, and overstatement of assets or understatement of liabilities. Misappropriation of assets typically involves external and internal schemes such as embezzlement, payroll fraud, and theft. Expenditures and liabilities for improper purposes refers to commercial and public bribery as well as other improper payment schemes. Fraudulently obtained revenue and assets, and costs and expenses avoided refers to schemes where an entity commits a fraud against its employees or third parties, or when an entity improperly avoids an expense such as, for example, when committing tax fraud,

In accordance with an embodiment of the present invention, the review performed in step 110 of method 100 includes assessing the effectiveness of the organization's anti-fraud control environment, assessing the effectiveness of the organization's fraud risks, and assessing the organization's anti-fraud controls.

When assessing the effectiveness of the organization's anti-fraud control environment, the organization's anti-fraud policies and procedures, if they exist, may be reviewed for completeness and relevance. Next, an organization-wide survey may be conducted, focusing particularly on anti-fraud controls, to establish the level of awareness, understanding, and consensus on their effectiveness. In accordance with an embodiment of the present invention, the survey is Web-based and can be completed anonymously. The survey contains a series of control statements, drafted by experts in this area, which are tailored for the organization's unique characteristics. Next, interviews with selected senior executives and staff may be conducted to follow-up on identified weaknesses and gaps for remediation. A controls environment remediation plan may be developed.

When assessing the effectiveness of the organization's fraud risks, the organization's business processes are mapped to a library of fraud risks by process, and a unique organization-specific library of potential fraud risks is created. The library of potential fraud risks may be both organization-wide and Sarbanes-Oxley specific. Next, an organization-wide fraud risk survey is conducted using extracts from the library in order to identify and establish a consensus on the key risk areas. Next, one or more risk workshops may be conducted at any or all of the corporate level, the business process level, or the financial statement level to engage the selected key players in a more detailed risk assessment exercise, and to identify appropriate controls to prevent or detect identified key fraud risks. Interviews with selected senior executives and staff may be conducted to follow up on identified key risks and to map out remediation plans. For example, a key fraud risk remediation plan may be developed.

When assessing the organization's anti-fraud controls, the organization's business processes are mapped to a library of fraud controls by process and a unique organization-specific library of potential fraud controls is created. The library of potential fraud controls may be both organization-wide and Sarbanes-Oxley specific. Next, an organization-wide controls review is conducted which leverages the fraud risk survey in order to identify the existence of adequate/inadequate controls in the identified key risk areas. A fraud controls survey is then conducted to capture views and to evaluate the effectiveness of controls in protecting against, detecting, or mitigating the impact of fraud. One or more risk workshops may be conducted at any or all of the corporate level, the business process level, or the financial statement level to engage the selected key players in a more detailed assessment exercise and to develop appropriate controls to fill gaps in areas of identified key fraud risks. Interviews with selected senior executives and staff may also be conducted to follow up on identified gaps in key controls and to map out remediation plans. For example, a key fraud control remediation plan may be developed.

Once the individuals, for which to male a determination of fraud risk, have been identified and those individuals have given their informed consent to go through the fraud risk determination process, the fraud risk determination process may begin. In accordance with an embodiment of the present invention, the step of obtaining informed consent includes educating each individual person selected about the fraud risk determination process.

FIG. 3 is a functional block diagram of an embodiment of a cooperative arrangement 300 to help deter and/or detect and/or mitigate fraud by evaluating the propensity of people to commit fraud, in accordance with various aspects of the present invention. The cooperative arrangement 300 includes a fraud risk evaluation entity 305 which includes a risk assessment algorithm 310 and a risk evaluation process 320. The cooperative arrangement 300 further includes an underwriting entity 330, as an option, and an investigative entity 340. The risk assessment algorithm 310 is adapted to accept information from at least one personal information disclosure statement 350 and at least one set of personal information records 360 and other relevant information. Each personal information disclosure statement 350 and each set of personal information records 360 and other relevant information is associated with one individual person. In accordance with certain embodiments of the present invention, the individual may choose whether to proceed with the fraud risk determination process. That is, the individual may or may not give his informed consent to engage in the determination process and may or may not give permissive use of his or her information records and data.

In accordance with an embodiment of the present invention, the risk evaluation entity 305 may be independent of the individual whose propensity to commit fraud is to be determined. The risk assessment algorithm 310 operates on the input information from the personal information disclosure statement(s) 350 and the set(s) of personal information records 360 and other relevant information and generates risk assessment data 3 15. The risk that is being assessed is the likelihood that an individual will attempt to commit fraud. The risk assessment data 315 is entered into the fraud risk evaluation process 320. The risk evaluation process 320 evaluates the risk assessment data 315 to make a determination of risk 370 with respect to one of an individual or to an organization.

If the decision is made to provide the determination 370, then the fraud risk determination is created. The determination may take the form of a quantitative score, a qualitative assignment to a risk category (with flexible and/or rigid thresholds), a certification, or a similar representation that indicates a relative likelihood of the individual or organization committing fraud. These scores may be publicly disclosed or kept confidential, depending on their intended use by individuals or organizations. A record of determination 380 is created for the individual person or the organization. This may or may not take the form of issuing a certificate of fraud risk determination. As an option, the underwriting entity 330 is used to conduct an underwriting procedure. That is, the underwriting entity 330 is used to generate and issue, or update, an insurance policy 390 in response to the determination results 374 of the risk evaluation process 320. For example, the individual may be added to an existing policy.

When the decision is made to provide the determination of fraud risk, the risk evaluation entity 305 has found that the risk associated with the individual or organization, with respect to committing fraud, is acceptable. If the decision is made not to provide the determination of fraud risk 370 (i.e., no determination will be provided), the decision must be made whether to investigate the underlying reasons for that decision 375. If the decision is made to investigate, then documented reasons for not providing the determination 372 are generated and forwarded to the investigative entity 340. If the decision is made not to investigate, the process ends 377, and the individual or organization does not receive any fraud risk determination.

In accordance with an embodiment of the present invention, the investigative entity 340 performs an investigation based on the documented reasons for not providing a risk determination 372 and generates a set of investigative results 345. Information from the investigative results 345 may be entered into the risk assessment algorithm 310, along with the personal information disclosure statement 350 and the set of personal information records 360 and other relevant information to generate a second set of risk assessment data 315 (i.e., investigation-based risk assessment data). As part of the investigation, the investigative entity 340 may ask for additional information from the individual(s), or may wish to interview the individual(s).

The second risk assessment data 315 is entered into the fraud risk evaluation process 320. The process 320 evaluates the second risk assessment data 315 to make a new investigated fraud risk determination 370 with respect to the individual(s) or the organization. Based on the additional information from the investigative results 345, the second risk assessment data 315 and, therefore, the decision whether to provide the fraud risk determination 370 may be the same as (i.e., “no”) or different from (i.e., “yes”) the original decision whether to provide the fraud risk determination 370. As a practical matter, there may be a limit to the number of times that an individual or organization will be investigated. That is, at some point, the attempts to determine the fraud risk will be stopped 377.

In accordance with an alternative embodiment of the present invention, personal information records and other relevant information of other persons associated with the individual may be obtained and entered into the risk assessment algorithm 310 along with the individual's information. Such other persons may include, for example, a spouse, a child, a sibling, a business partner, or a parent of the individual. Such information of other persons may be helpful if, for example, an individual were to try to hide embezzled funds in an account held in the name of a close friend or relative.

FIG. 4 illustrates a flowchart of a first embodiment of a method 400 which is conducted to help deter and/or detect and/or mitigate fraud by evaluating the propensity of an individual associated with an organization, an individual potentially to be associated with an organization, or an individual acting in his or her individual capacity to commit fraud, using the cooperative arrangement 300 of FIG. 3, in accordance with various aspects of the present invention. In step 410, a personal information disclosure statement of an individual is obtained. In step 420, personal information records and other relevant information of the individual are obtained. In accordance with an embodiment of the present invention, step 420 is performed only if the individual gives permission. In step 430, first information from the personal information disclosure statement, the personal information records, and other relevant information is entered into a risk assessment algorithm. In step 440, the risk assessment algorithm operates on the first input information and thereby generates first risk assessment data. In step 450, the first risk assessment data is evaluated to make a first determination of fraud risk with respect to the individual. In accordance with an alternative embodiment of the present invention, only information from personal information records and other relevant information are used. A personal information disclosure statement may not be obtained.

As an example, referring to FIG. 3, an individual associated with a corporation is to be assessed for fraud risk by the fraud risk evaluation entity 305. In accordance with an embodiment of the present invention, the fraud risk evaluation entity 305 is preferably, but not necessarily, an independent entity which is in the business of assessing the fraud risk posed by individuals of organizations (e.g., publicly held corporations, non-publicly held corporations, government entities). Such fraud risk determinations help to increase the likelihood that the individual will comply with policies, procedures, rules, best practices, ethical and moral standards, and controls of the organization such as, for example, complying with Sarbanes-Oxley regulations. Such a fraud risk determination also helps to ensure that the individual is less likely to engage in fraudulent activities such as, for example, the embezzlement of organizational funds.

Continuing with the example, the individual registers with the risk evaluation entity 305 and provides a personal information disclosure statement 350 to that entity 305. Information provided on the personal information disclosure statement may include, for example, information related the individual's assets (e.g., home ownership), liabilities (e.g., credit card debt), and income (e.g., a salary). The individual also gives permission to the risk evaluation entity 305 to obtain past and present personal information records 360 and other relevant information such as, for example, tax return records, treasury records, real estate records, banking records, or credit reports and scores.

Information is extracted from the personal information disclosure statement 350 and the personal information records 360 and other relevant information and is entered into the risk assessment algorithm 310. The risk assessment algorithm 310 operates on the input information and generates risk assessment data 315. The risk assessment data 315 may include, for example, detected discrepancies found when comparing the individual's personal information disclosure statement 350 and the personal information records 360. For example, a discrepancy between what was claimed as income and what was recorded as income may be found. Also, for example, evidence of irresponsible financial behavior may be detected (e.g., not paying minimum balances due on credit cards), evidence of suspicious/anomalous behavior may be found (e.g., an unusual transfer of funds, a sudden move or change of residence), or financial instability may be detected (e.g., a lender is about to foreclose on the individual's home). Many other risk assessment data are possible as well, in accordance with various embodiments of the present invention. The weighting of these and other factors may vary by design.

Next, the risk assessment data 315 enters the fraud risk evaluation process 320. In accordance with an embodiment of the present invention, the risk assessment data 315 is operated on by the fraud risk evaluation process 320 to generate a fraud risk determination in response to the risk assessment data 315. The fraud risk determination is a reliable indicator of the individual's level of risk with respect to fraudulent activity. In accordance with an embodiment of the present invention, the fraud risk determination may take the form of a quantitative score, a qualitative assignment to a risk category (with flexible and/or rigid thresholds), a certification, or a similar representation that indicates a relative likelihood of the individual or organization committing fraud. In the case where the fraud risk determination is a single numeric value or score, it is compared to a threshold value which is also a numeric value.

If the fraud risk determination is greater than the threshold value, then a decision not to provide the determination is made. If the fraud risk determination is less than the threshold value, then a decision to provide the determination is made. In accordance with an alternative embodiment of the present invention, if the resultant fraud risk determination is within a predefined range of values about the threshold value, a decision to delay providing the determination is made and further action is taken to determine if the fraud risk determination can be lowered (i.e., if the risk can be reduced) in order to make subsequently a decision to provide the determination. Other means of comparing a fraud risk determination are possible as well, in accordance with various other embodiments of the present invention.

In accordance with an alternative embodiment of the present invention, the risk assessment algorithm 310 and the fraud risk evaluation process 320 are implemented as a single algorithm or process. In accordance with an embodiment of the present invention, the risk assessment algorithm 3 10 and/or the fraud risk evaluation process 320 are both implemented on a processor-based platform such as, for example, a personal computer. In accordance with various embodiments of the present invention, the fraud risk evaluation process 320 may be performed manually by a human, or may be performed automatically by a processor-based platform.

In the case where a decision to provide the fraud risk determination is made, the determination results 374 may be generated and forwarded to the underwriting entity 330, as an option in accordance with an embodiment of the present invention, the provided information 374 may include, for example, the resultant fraud risk determination and the threshold value used, certain specified personal identification information of the individual and other certain information associated with the individual that were used to generate the fraud risk determination. The underwriting entity 330 may be an insurance company, in accordance with certain embodiments of the present invention, and may be independent of the fraud risk evaluation entity 305 and the investigative entity 340.

In accordance with an embodiment of the present invention, underwriting includes insuring the organization by accepting liability for designated losses arising from fraudulent activities by the individual. The underwriting entity 330 takes the determination results 374 and underwrites the organization by generating or adjusting an insurance policy having terms, conditions, and premium fees which are calculated in response to, at least in part, the determination results 374. This could be part of a wide variety of insurance products, including ones newly created in response to the present invention and ones existing (such as Directors & Officers, Crime, and Fidelity insurance) but improved through the use of the present invention.

For example, if the individual's calculated fraud risk determination is well below the threshold value, then the insurance premium that is to be paid for the insurance policy may be reduced or discounted from a standard rate of someone not having the fraud risk determination or of someone having a higher-fraud risk determination. Also, the terms and conditions of the insurance policy may be more favorable. For example, the amount of time that can pass before the individual is to be re-certified may be longer. Also, monitoring of the individual's future personal information may be less frequent. In accordance with an embodiment of the present invention, the insurance premiums may be paid by the organization of the individual. As a result, the organization may be able to eliminate other forms of insurance coverage.

If new information is obtained on an individual and processed through the fraud risk evaluation entity 305 and the resultant updated fraud risk determination, based on the new information, is better than a previously calculated fraud risk determination, then the underwriting may be updated (i.e., premiums, terms, and/or conditions may be re-calculated) as well based on the improved fraud risk determination. Similarly, if the resultant updated fraud risk determination is worse, then less favorable underwriting premiums, terms, and/or conditions may be provided. For example, updating an underwriting of the organization may be made if a decision is to provide the fraud risk determination and the updated fraud risk determination is closer to the threshold value than a previously calculated fraud risk determination for the individual.

In the case where a decision not to provide the fraud risk determination is made, the decision is made whether to investigate the underlying reasons for that decision 375. If the decision is made to investigate, then documented reasons for not providing the determination 372 are generated and forwarded to the investigative entity 340. In accordance with an embodiment of the present invention, the investigative entity 340 is a private agency or entity with expertise in investigating personal information matters of individuals. The investigative entity 340 takes the documented reasons for not providing the fraud risk determination 372 and determines the underlying circumstances involved and generates corresponding investigation results 345. In accordance with an alternative embodiment of the present invention, the investigative entity 340 is not independent of the fraud risk evaluation entity 305 and/or the organization and may be an integral pair of the entity 305, or a branch of the entity 305.

For example, the individual's fraud risk determination may be too risky because the individual is seen to own shares of stock in a competing corporation. Upon investigation, the investigative entity 340 determines that the shares of stock were purchased for the individual as a child by her father many years ago. The individual had forgotten about the shares of stock and, therefore, failed to disclose them on her personal information disclosure statement 350. The investigative results 345 are then forwarded to the fraud risk evaluation entity 305 along with a recommendation that the individual sell the problematic shares of stock. Upon selling the shares of stock, information is extracted from the investigative results 345 and entered into the risk assessment algorithm 310 along with the fact that the individual no longer owns the shares of stock, and along with the information previously extracted from the individual's personal information disclosure statement 350, personal information records 360, and other relevant information.

An updated set of risk assessment results 315 is generated, and an updated fraud risk determination, which is substantially better than the original fraud risk determination, is generated. Upon comparing the updated fraud risk determination to a threshold value, for example, a decision to provide the fraud risk determination for the individual is made. As a result, the individual receives, and/or the individual's organization receives, the determination, and the underwriting process may proceed if desired.

In accordance with an embodiment of the present invention, the risk assessment algorithm 310 takes the input information and generates a set of internal parameters. The risk assessment algorithm then applies weightings to the set of internal parameters and combines the weighted internal parameters in a particular way to generate the risk assessment results 315. Certain weighted internal parameters and/or combinations of weighted internal parameters may be applied to certain internal thresholds in a certain manner to generate particular risk assessment results 315 (e.g., binary risk assessment results).

In accordance with a further embodiment of the present invention, the risk assessment algorithm 310 is a heuristic algorithm that can evolve over time as the risk assessment algorithm 310 is presented with additional information along with output data corresponding to the input information. For example, information from a known first group of individuals who have deliberately not complied with corporate governance rules and procedures and/or who are known to have committed fraud may be entered into the risk assessment algorithm 310 along with the fact that these individuals should not be provided a fraud risk determination (i.e., the algorithm should be able to adapt to generate risk assessment data 315 that detects a problem with this first group of individuals with respect to fraud risk). Similarly, information from a known second group of individuals who have always complied with corporate governance rules and procedures and are known to have not committed fraud may be entered into the risk assessment algorithm 310 along with the fact that these individuals should be provided a fraud risk determination (i.e., the algorithm should be able to adapt to generate risk assessment data that does not detect a problem with this second group of individuals with respect to fraud risk).

Similarly, in accordance with a still further embodiment of the present invention, the fraud risk evaluation process 320 is a heuristic algorithm that can evolve over time as the fraud risk evaluation process 320 is presented with new risk assessment data 315 along with additional data corresponding to the new risk assessment data 315. For example, when presented with the risk assessment data 315 corresponding to the known individuals who deliberately did not comply with corporate governance rules and procedures and who committed fraud, the fraud risk evaluation process 320 may adapt in order to generate correctly a decision not to provide a fraud risk determination 370. Such an adaptation may involve adapting the formula for calculating the fraud risk determination and/or changing a threshold value. Similarly, when presented with the risk assessment data 315 corresponding to the known individuals who always complied with corporate governance rules and procedures and did not commit fraud, the fraud risk evaluation process 320 may adapt in order to generate correctly a decision to provide a fraud risk determination step 370.

Typically, the risk assessment algorithm 310, the risk evaluation process 320, and the fraud risk determination step 370 are allowed to evolve simultaneously in order to take into account new data entered. Such heuristic algorithms may be implemented as, for example, genetic algorithms and/or neural network-based algorithms on processor-based platforms, in accordance with various embodiments of the present invention.

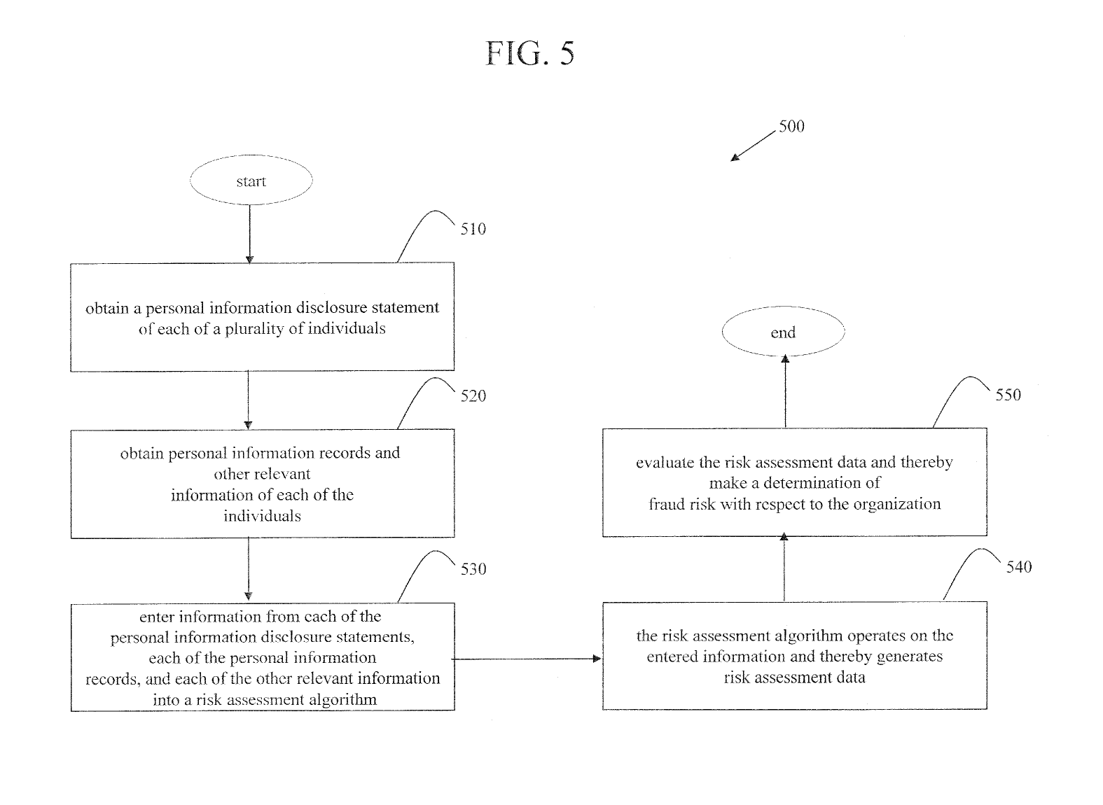

Just as a single individual can receive fraud risk determinations (and be optionally underwritten), an entire organization may also be receive a fraud risk determination (and be optionally underwritten), in accordance with an embodiment of the present invention. FIG. 5 illustrates a flowchart of a second embodiment of a method 500 which is conducted to help deter and/or detect and/or mitigate fraud by evaluating the propensity of an organization to commit fraud, using the cooperative arrangement of FIG. 3, in accordance with various aspects of the present invention. In step 510, a personal information disclosure statement of each of a plurality of individuals associated with an organization is obtained. In step 520, personal information records of each of the individuals and other relevant information are obtained. In step 530, information is extracted from each of the personal information disclosure statements, each of the personal information records, and each of the other relevant information and entered into a risk assessment algorithm. In step 540, the risk assessment algorithm operates on the entered information and thereby generates risk assessment data. In step 550, the risk assessment data is evaluated and thereby a determination of fraud risk is made with respect to the organization.

Therefore, for example, by applying the cooperative arrangement 300 of FIG. 3 to all of the individuals of an organization that handle or have direct or even indirect input to any of the certified financial statements of the organization, the entire organization may receive fraud risk determinations, and become optionally underwritten, as having a lower risk of fraud. Just as for an individual, a fraud risk determination may be generated for the entire organization and compared to a threshold value. The underwriting and/or investigative process illustrated in FIG. 3 may be followed with respect to the entire organization (e.g., a publicly held corporation), based on assessing the risk associated with a plurality of individuals.

Alternatively, the method 400 of FIG. 4 may simply be repeated for each of the individuals of the organization and, therefore, the organization receives the fraud risk determination only after each of those individuals receives individual fraud risk determinations.

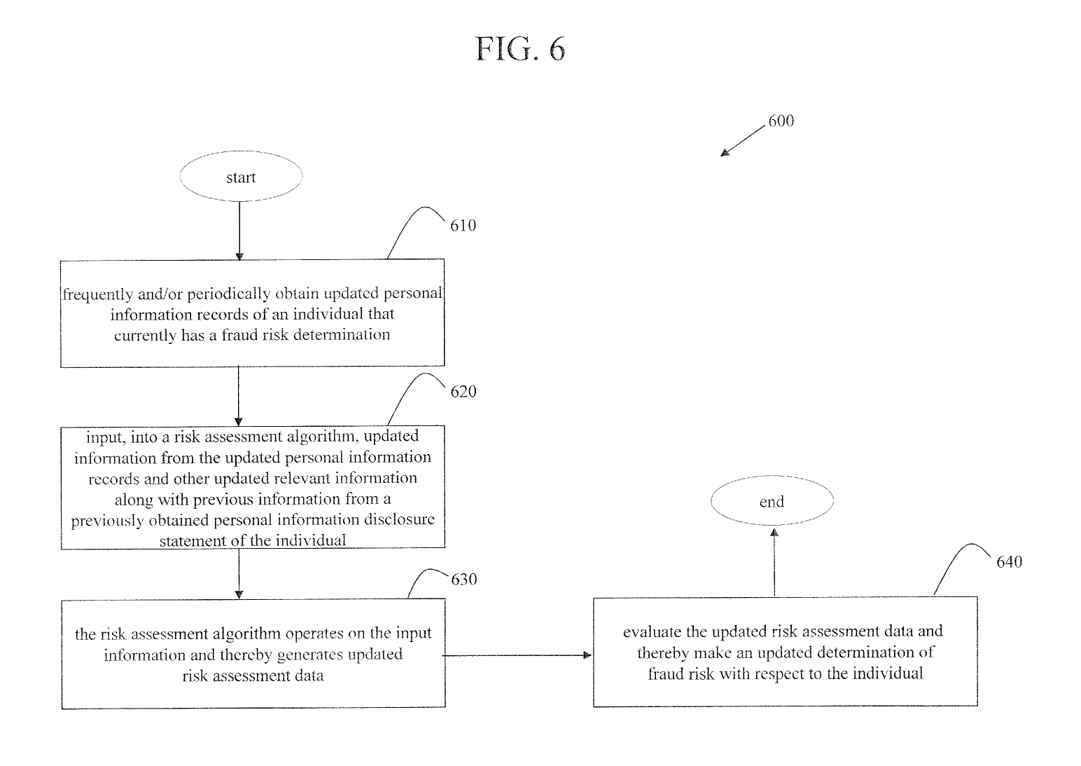

FIG. 6 illustrates a flowchart of an embodiment of a method 600 which is conducted to help deter and/or detect and/or mitigate fraud by monitoring the information of an individual, or a plurality of individuals, associated with an organization, an individual potentially to be associated with an organization, or an individual acting in his or her individual capacity for changes in fraud risk, using the cooperative arrangement of FIG. 3, in accordance with various aspects of the present invention. In step 610 updated personal information records of an individual that currently has a fraud risk determination are frequently and/or periodically obtained. In step 620, updated information from the updated personal information records and other relevant information is input (entered) into a risk assessment algorithm along with information of the individual previously obtained. In step 630, the risk assessment algorithm operates on the input information and thereby generates updated risk assessment data. In step 640, the updated risk assessment data is evaluated and an updated determination of fraud risk is made with respect to the individual.

For example, an individual of a corporation who has a current fraud risk determination and is covered under one of the organization's insurance policies 390 may be required to allow updated (i.e., most-recent) personal information records to be obtained by the fraud risk evaluation entity 305 every fiscal quarter, in accordance with the terms of the corresponding policy 390. As a result, the fraud risk evaluation entity 305 is able to monitor effectively the individual's information to see if any significant changes have occurred that could affect the individual's risk of committing fraud. Another individual of the corporation may be required to provide updated personal information records only once a year, because of the individual's superior fraud risk determination (i.e., lower risk of committing fraud) and superior underwriting status.

In accordance with an alternative embodiment of the present invention, the financial status of an individual may be, effectively, continuously monitored. That is, as soon as updated personal information for an individual becomes available, the information is immediately entered into the risk assessment algorithm and processed. The individual's financial behavior is, in effect, constantly tracked.

If the individual's fraud risk determination deteriorates too much, then the investigative process previously described may be followed. As another example, if the individual's fraud risk determination changes (i.e., improves or degrades but still is acceptable for maintaining the fraud risk determination), the terms, conditions, and/or premiums of the associated underwritten policy for the individual's company may be updated to reflect the changed risk. If no significant changes result, the previous fraud risk determination and underwritten policy may be maintained.

In accordance with an alternative embodiment of the present invention, the individual may provide an updated personal information disclosure statement which is then also used in the monitoring process.

The method 600 of FIG. 6 can also serve as a first indicator of identity theft for the monitored individual. Any unusual activity due to any form of identity theft may be detected by the fraud risk evaluation entity 305, or by the investigative entity 340. For example, if the individual's credit card number were stolen and used in such a way that would be considered unusual for the individual (e.g., sudden fluctuations in the account balance are seen), such an unauthorized use may be detected by the risk assessment algorithm 310.

Employees of the organization for which the individual works may be encouraged to report to the fraud risk evaluation entity 305 any observed misconduct on the part of the individual. In this way, a reporting employee is reporting to an entity which may or may not be independent of his/her employer and, therefore, may be less reluctant to report such misconduct without fear of retaliation from the employer (i.e., from the organization by which the individual and the reporting employee are employed).

In accordance with an alternative embodiment of the present invention, there may be multiple levels or degrees of fraud risk determinations. For example, “gold”, “silver”, and “bronze” levels of certification may be defined based on ranges of possible numeric values that the fraud risk determination can be. As another example, levels of fraud risk determination may be defined based on the number of years that an individual has held a fraud risk determination (e.g., 5-year determination, 10-year determination, etc.).

In accordance with a further alternative embodiment of the present invention, fraud risk determinations may be influenced by the particular position within an organization that an individual holds. For example, the fraud risk determination requirement for a CEO may be different than that for a head of marketing. As another example, the exact risk assessment algorithm used may be somewhat different for a CEO than for a head of marketing.

In accordance with various embodiments of the present invention, fraud risk determinations may be mandatory or may be voluntary. For example, there may be an employee of an organization that is not required to have a fraud risk determination but would like to go through the process (possibly excluding the underwriting part of the process) in order to establish herself as an exemplary person of trustworthiness. Such voluntary participation may be desirable, for example, because it may help the employee gain a promotion into a position of greater responsibility, for example.

As another example, a private employer (i.e., not a publicly held company) may decide that all of his employees must receive fraud risk determinations, in accordance with an embodiment of the present invention, in order to remain or become employed at his private company. That is, in this example fraud risk determination is made a condition of employment. Such a mandatory prerequisite for employment can allow the private employer to hire and retain only those people that are the least likely to commit fraud.

In summary, a cooperative arrangement and methods of helping to deter, detect, and mitigate fraud are disclosed. Information is collected for individual(s) and entered into a risk assessment algorithm to determine a level of fraud risk with respect to the individual(s) and/or their organization(s). If the level of risk is acceptable, the individual may receive a fraud risk determination and may be optionally underwritten in order to protect the organization against fraud by the individual.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to assess risk of fraud within an organization, said method including:
(a) performing a review of an organization's business processes with respect to fraud risk;
(b) generating a first business process fraud risk map based on said review by generating and assigning first risk values to said business processes of said organization;
(c) correlating said business process fraud risk map to positions of responsibility within said organization; and
(d) generating and assigning second fraud risk values to said correlated positions based on said correlating.

2. The method of claim 1 further including:
(e) adjusting at least one of said business processes to change at least one said corresponding first risk value reflecting a reduced risk;
(f) generating a second business process fraud risk map based on said adjusting by re-assigning said at least one changed first risk value to said at least one adjusted business process of said organization;
(g) re-correlating said second business process fraud risk map to said positions of responsibility within said organization; and
(h) changing at least one of said second risk values and re-assigning said second risk values to said re-correlated positions based on said re-correlating.

3. The method of claim 2 further including repeating steps (e) through (h) until the number of said positions having a second risk value being on a higher-risk side of a risk threshold value indicates an acceptable level of risk.

4. The method of claim 3 further including:
identifying individual persons within said organization holding said positions having a second risk value being on said higher-risk side of said risk threshold value;
selecting at least one of said identified individual persons to go through a fraud risk determination process;
attempting to obtain an informed consent from each said individual person selected to go through said fraud risk determination process; and
having each said consenting individual person go through said fraud risk determination process.

5. The method of claim 4 wherein said fraud risk determination process for each said consenting individual person includes:
obtaining a personal information disclosure statement from said individual person;
obtaining personal information records and other relevant data of said individual person;
inputting first information extracted from said personal information disclosure statement, said personal information records, and said other relevant financial data into a risk assessment algorithm;
said risk assessment algorithm operating on said first input information and thereby generating first risk assessment data associated with said individual person; and
evaluating said first risk assessment data and thereby making a first determination of fraud risk with respect to said individual person.

6. The method of claim 1 wherein said review includes:
assessing an effectiveness of said organization's anti-fraud control environment;
assessing an effectiveness of said organization's fraud risks; and
assessing said organization's anti-fraud controls.

7. The method of claim 6 wherein said assessing an effectiveness of said organization's anti-fraud control environment includes:
reviewing said organization's anti-fraud policies and procedures for at least completeness and relevance;
conducting an organization-wide survey focused on anti-fraud controls;
interviewing selected persons within said organization in response to results of said survey; and
generating a controls environment remediation plan in response to at least one of said reviewing, said survey, and said interviewing.

8. The method of claim 6 wherein said assessing an effectiveness of said organization's fraud risks includes:
mapping said business processes of said organization to a library of fraud risks to generate a unique, organization-specific library of potential fraud risks;
conducting an organization-wide fraud risk survey based on said library of potential fraud risks;
conducting at least one risk workshop to identify controls to detect and/or prevent key fraud risks;
interviewing selected persons within said organization in response to results of said fraud risk survey and/or said at least one risk workshop; and
generating a key fraud risk remediation plan in response to at least one of said mapping, said survey, said workshops, and said interviewing.

9. The method of claim 8 wherein said assessing said organization's anti-fraud controls includes:
mapping said business processes of said organization to a library of fraud controls to generate a unique, organization-specific library of potential fraud controls;
conducting an organization-wide controls review based on said library of potential fraud controls and using said fraud risk survey to identify adequate/inadequate anti-fraud controls in identified key risk areas;
conducting a fraud controls survey to capture views and evaluate an effectiveness of said anti-fraud controls;
conducting at least one other risk workshop to develop controls to fill gaps in said identified key risk areas;
interviewing selected persons within said organization in response to results of said fraud controls survey and/or said at least one other risk workshop; and
generating a key fraud control remediation plan in response to at least one of said mapping, said survey, said workshop, and said interviewing.

10. The method of claim 1 wherein each of said second risk values falls into a defined category of risk including a highest category of risk, an intermediate category of risk, and a lowest category of risk.

11. The method of claim 1 wherein said organization comprises a publicly held corporation.

12. The method of claim 1 wherein said organization comprises a non-publicly held corporation.

13. The method of claim 1 wherein said organization comprises a government entity.

14. The method of claim 1 wherein said organization comprises a sports team.

15. The method of claim 1 wherein said organization comprises a private business.

16. The method of claim 1 wherein said organization comprises a not-for-profit entity.

17. The method of claim 5 wherein said personal information records include at least one of tax return records, treasury records, real estate records, banking records, or credit reports and scores.

18. The method of claim 5 wherein said personal information disclosure statement includes information related to financial assets, liabilities, and income of said individual person.

19. The method of claim 4 wherein said fraud risk determination process is conducted by an entity which is independent of said organization and said individual persons to be certified.

20. The method of claim 4 wherein the step of obtaining informed consent includes educating said each individual person selected about said fraud risk determination process.
